(19) United States
(12) Patent Application Publication
(10) Pub. No.: US 2016/0277625 A1
(43) Pub. Date: Sep. 22, 2016

(54) IMAGE CAPTURE DEVICE CAPABLE OF UPLOADING CLEAR IMAGES VIA WIRELESS TRANSMISSION

(71) Applicant: DIGILIFE TECHNOLOGIES CO., LTD., Taipei City (TW)

(72) Inventors: CHEN-PING YANG, Taipei City (TW); CHIN-FA WANG, Taipei City (TW); SHIH-CHI CHANG, Taipei City (TW)

(21) Appl. No.: 14/660,658

(22) Filed: Mar. 17, 2015

(51) Int. Cl. H04N 1/21; H04N 1/00

(52) U.S. Cl. CPC H04N 1/2112; H04N 1/00103; H04N 2201/0084; H04N 2201/0055

(57) ABSTRACT

An image capture device capable of uploading clear images via wireless transmission includes a central processing unit, an image capture unit electrically coupled to the central processing unit, an image memory unit, a clear image detection unit electrically coupled to the central processing unit, and a wireless transmission unit electrically coupled to the central processing unit and these units are operated together to upload clear images, particularly to upload clear images to an external storage device via wireless transmission.

### FIELD OF THE INVENTION

The present invention relates to an image capture device capable of uploading clear images via wireless transmission, in particular to the image capture device capable of uploading clear images to an external storage device via wireless transmission.

### BACKGROUND OF THE INVENTION

As the quality of life improves, almost everyone has an image capture device such as a Smartphone, a digital camera, a driving recorder, a life recorder, etc, but when a general image capture device uploads the captured images to an external storage device via wireless transmission, the image capture device can just upload all images, and thus the external storage device will store blurred images.

Therefore, it is a main subject of the present invention to develop an image capture device capable of uploading clear image to an external storage device via wireless transmission.

### SUMMARY OF THE INVENTION

In view of the aforementioned drawback of the conventional image capture device, the inventor of the present invention based on years of experience in the related industry to conduct extensive researches and experiments, and finally designed and developed an image capture device capable of uploading clear images via wireless transmission in accordance with the present invention to overcome the drawback of the prior art.

To achieve the aforementioned and other objectives, the present invention provides an image capture device capable of uploading clear images via wireless transmission, and the image capture device comprises: a central processing unit; an image capture unit, electrically coupled to the central processing unit; an image memory unit, electrically coupled to the central processing unit; a clear image detection unit, electrically coupled to the central processing unit; and a wireless transmission unit, electrically coupled to the central processing unit, and the aforementioned units (especially the clear image detection unit) are operated together to upload clear images via wireless transmission.

In the aforementioned image capture device, the clear image detection unit is a clear image detection chip, a clear image detection circuit board or a clear image detection software.

In the aforementioned image capture device, the wireless transmission unit is a wireless fidelity (Wi-Fi) transmission device, a Bluethooth transmission device, a radio frequency (RF) transmission device, a third generation (3G) transmission device or a fourth generation (4G) transmission device.

In the aforementioned image capture device, the central processing unit is a central processing circuit board, and the central processing circuit board has a central processing unit.

In the aforementioned image capture device, the image capture unit is a charge coupled device (CCD) or a complementary metal oxide semiconductor (CMOS).

In the aforementioned image capture device, the image memory unit has an internal memory, or an internal memory and an external memory.

The aforementioned image capture device further comprises a display unit and a power supply unit, or a display unit, a power supply unit and a global positioning system unit.

Therefore, the image capture device of the present invention is capable of uploading clear images to an external storage device via wireless transmission.

### BRIEF DESCRIPTION OF THE DRAWING

FIG. 1 is a schematic view of a preferred embodiment of the present invention.

### DETAILED DESCRIPTION OF THE PREFERRED EMBODIMENTS

The objects, characteristics and effects of the present invention will become apparent with the detailed description of the preferred embodiments and the illustration of related drawings as follows.

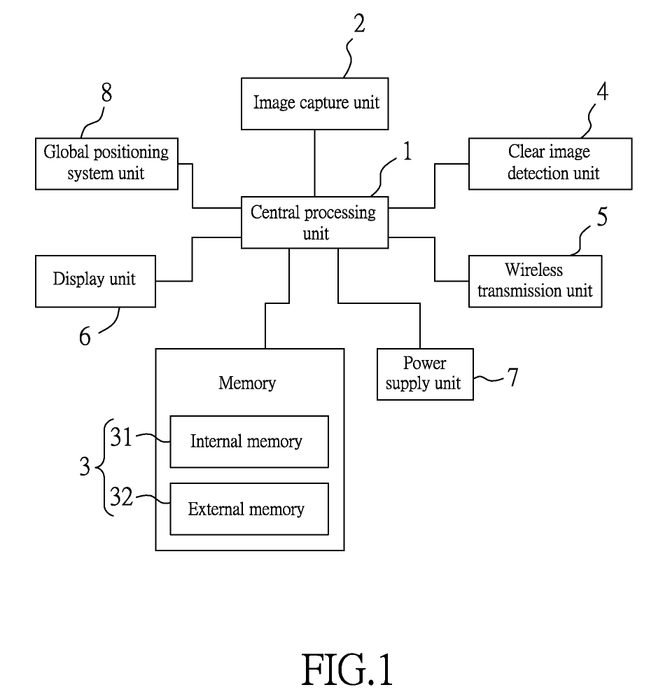

With reference to FIG. 1 for an image capture device capable of uploading clear images via wireless transmission in accordance with the present invention, the image capture device may be a Smartphone, a digital camera, a driving recorder, a life recorder, etc, and the image capture device comprises a central processing unit 1, an image capture unit 2, an image memory unit 3, a clear image detection unit 4 and a wireless transmission unit 5. Wherein, the image capture unit 2 is electrically coupled to the central processing unit 1, and the image capture unit 2 is provided for converting the captured images into electronic image data and transmitting the electronic image data to the central processing unit 1 for further processing; the image memory unit 3 is electrically coupled to the central processing unit 1, and the central processing unit 1 is provided for transmitting the electronic image data to the image memory unit 3 for storage, or retrieving the electronic image data from the image memory unit 3 for further processing; the clear image detection unit 4 is electrically coupled to the central processing unit 1, and the wireless transmission unit 5 is electrically coupled to the central processing unit 1, so that the clear image detection unit 4 and the wireless transmission unit 5 are operated to cooperate with each other by the central processing unit 1. If it is necessary to collectively upload the electronic image data stored in the image memory unit 3 to an external storage device (such as a cloud hard drive) via wireless transmission, the electronic image data will be transmitted to the central processing unit 1 first, and then the central processing unit 1 together with the clear image detection unit 4 will detect whether or not the electronic image data are clear images. If the electronic data are blurred images, the electronic image data will not be uploaded to the external storage device. If the electronic data are clear images, the electronic image data will be uploaded to the external storage device via wireless transmission by the central processing unit 1 and the wireless transmission unit 5. Similarly, if it is necessary to collectively upload the electronic image data converted from the images captured by the image capture unit 2 to an external storage device (such as a cloud hard drive), the electronic image data will be transmitted to the central processing unit 1 first, and then the central processing unit 1 together with the clear image detection unit 4 will detect whether or not the electronic image data are clear images. If the electronic data are blurred images, the electronic image data will not be uploaded to the external storage device, but they will remain in the image memory unit 3. If the electronic data are clear images, the electronic image data will be uploaded to the external storage device via wireless transmission by the central processing unit 1 and the wireless transmission unit 5, and stored in the image memory unit 3.

There are different methods provided for the clear image detection unit 4 to detect whether or not the electronic image data are clear images. For example, the clear image detection unit 4 operated together with the central processing unit 1 detects a clarity value of the whole image. If the smallest value or the sum of all clarity values is greater than or equal to an approved clarity value, then the electronic image data will be considered as clear mages. If the smallest value or the sum of all clarity values is smaller than the approved clarity value, then the electronic image data will be considered as blurred images. To expedite the detection, the clear image detection unit 4 will be operated together with the central processing unit 1 to detect the clarity value of a local area of an image. If the smallest value or the sum of all clarity values in the local area is greater than or equal to an approved clarity value, the electronic image data will be considered as clear images. If the smallest value or the sum of all clarity values in the local area is smaller than the approved clarity value, the electronic image data will be considered as blurred images.

In summation of the description above, the present invention provides an image capture device capable of uploading clear images via wireless transmission in accordance with the present invention, wherein all clear images stored in the image memory unit 3 are uploaded to an external storage device via wireless transmission without requiring users to review and compile the images. After the clear images captured by the image capture unit 2 are converted into electronic image data, the clear images are uploaded to the external storage device via wireless transmission without requiring users to review and compile the images. If it is necessary to collectively upload the electronic image data via wireless transmission or upload the electronic image data instantly via wireless transmission, the upload operation may be selected by a select switch (not shown in the FIGURE) electrically coupled to the central processing unit 1.

In the aforementioned image capture device capable of uploading clear images via wireless transmission as shown in FIG. 1, the clear image detection unit 4 is a clear image detection chip, a clear image detection circuit board or a clear image detection software, for detecting whether or not the electronic image data are clear images.

In the aforementioned image capture device capable of uploading clear images via wireless transmission as shown in FIG. 1, the wireless transmission unit 5 is a wireless fidelity (Wi-Fi) transmission device, a Bluethooth transmission device, a radio frequency (RF) transmission device, a third generation (3G) transmission device or a 4G fourth generation (4G) transmission device, operated together with the central processing unit 1 and the clear image detection unit 4 to upload clear electronic image data to an external storage device via wireless transmission.

In the aforementioned image capture device capable of uploading clear images via wireless transmission as shown in FIG. 1, the central processing unit 1 is a central processing circuit board having a central processing unit for processing the electronic image data.

In the aforementioned image capture device capable of uploading clear images via wireless transmission as shown in FIG. 1, the image capture unit 2 is a charge coupled device (CCD) or a complementary metal oxide semiconductor (CMOS) for converting the captured images into, electronic image data.

In the aforementioned image capture device capable of uploading clear images via wireless transmission as shown in FIG. 1, the image memory unit 3 includes an internal memory 31, or an internal memory 31 and an external memory 32, for storing the electronic image data, and the external memory 32 is a memory card or a flash drive.

The aforementioned image capture device capable of uploading clear images via wireless transmission as shown in FIG. 1 further comprises a display unit 6 and a power supply unit 7, or a display unit 6, a power supply unit 7 and a global positioning system unit 8. The display unit 6 is a liquid crystal display (LCD) display device or a light emitted diode (LED) display device for displaying an image stored in the image memory unit 3 or an image captured by the image capture unit 2. The power supply unit 7 is a secondary battery or an electric socket and an electric wire electrically coupled to the mains power supply and provided for supplying electric power to all of the aforementioned electronic devices. The global positioning system unit 8 is a global positioning system for locating the position of the image capture device or recording the location where the image is captured.

While the invention has been described by means of specific embodiments, numerous modifications and variations could be made thereto by those skilled in the art without departing from the scope and spirit of the invention set forth in the claims.

What is claimed is:

1. An image capture device capable of uploading clear images via wireless transmission, comprising:
a central processing unit;
an image capture unit, electrically coupled to the central processing unit;
an image memory unit, electrically coupled to the central processing unit;
a clear image detection unit, electrically coupled to the central processing unit; and
a wireless transmission unit, electrically coupled to the central processing unit and operated together with the clear image detection unit to upload the clear images via wireless transmission.

2. The image capture device capable of uploading clear images via wireless transmission as claimed in claim 1, wherein the clear image detection unit is a clear image detection chip, a clear image detection circuit board or a clear image detection software.

3. The image capture device capable of uploading clear images via wireless transmission as claimed in claim 1, wherein the wireless transmission unit is a wireless fidelity (Wi-Fi) transmission device, a Bluethooth transmission device, a radio frequency (RF) transmission device, a third generation (3G) transmission device or a fourth generation (4G) transmission device.

4. The image capture device capable of uploading clear images via wireless transmission as claimed in claim 1, wherein the central processing unit is a central processing circuit board, and the central processing circuit board has a central processing unit.

5. The image capture device capable of uploading clear images via wireless transmission as claimed in claim 1, wherein the image capture unit is a charge coupled device (CCD) or a complementary metal oxide semiconductor (CMOS).

6. The image capture device capable of uploading clear images via wireless transmission as claimed in claim 1, wherein the image memory unit has an internal memory, or an internal memory and an external memory.

7. The image capture device capable of uploading clear images via wireless transmission as claimed in claim 1, further comprising a display unit and a power supply unit, or a display unit, a power supply unit and a global positioning system unit.
